(19) United States
(12) Patent Application Publication
(10) Pub. No.: US 2012/0117961 A1
(43) Pub. Date: May 17, 2012

(54) BRAKE ACTUATOR UNIT FOR ACTUATING A MOTOR VEHICLE BRAKING SYSTEM OF THE "BRAKE-BY-WIRE" TYPE

(75) Inventors: Thomas Sellinger, Offenbach (DE); Peter Drott, Frankfurt/Main (DE); Horst Krämer, Ginsheim-Gustavsburg (DE)

(73) Assignee: CONTINENTAL TEVES AG & CO. oHG, Frankfurt (DE)

(21) Appl. No.: 13/262,062

(22) PCT Filed: Mar. 18, 2010
(86) PCT No.: PCT/EP10/53510

§ 371 Date: Dec. 19, 2011

(30) Foreign Application Priority Data
Apr. 2, 2009 (DE) 10 2009 002 156.6
Mar. 15, 2010 (DE) 10 2010 002 848.7

(51) Int. Cl. B60T 13/74

(52) U.S. Cl. 60/545

(57) ABSTRACT

A brake actuator unit for actuating a motor vehicle braking system of the “brake-by-wire” type, having a brake booster which can be actuated by a brake pedal and by an electronic control unit as a function of a driver's request and has a piston rod, a master brake cylinder arranged downstream of the brake booster, and a pedal travel simulator which interacts with the brake pedal and is arranged in parallel with the piston rod and by which, in the “brake-by-wire” mode, a restoring force acting on the brake pedal can be simulated independently of actuation of the brake booster. In order to decouple a force-transmitting connection between the brake pedal and the brake booster in the “brake-by-wire” mode, a distance ‘a’ is provided between the brake pedal and a component arranged downstream in the force flux and assigned to the brake booster.

### CROSS REFERENCE TO RELATED APPLICATIONS

This application is the U.S. National Phase Application of PCT International Application PCT/EP2010/053510, filed Mar. 18, 2010, which claims priority to German Patent Application No. 10 2009 002 156.6, filed Apr. 2, 2009, and German Patent Application No. 10 2010 002 848.7, filed Mar. 15, 2010, the contents of such applications being incorporated by reference herein.

### FIELD OF THE INVENTION

The invention relates to a brake actuator unit for actuating a motor vehicle braking system of the “brake-by-wire” type, having a brake booster which can be actuated both by means of a brake pedal and by means of an electronic control unit as a function of a driver's request and has a piston rod, a master brake cylinder arranged downstream of the brake booster, means for registering a driver deceleration request, and a pedal travel simulator which interacts with the brake pedal and is arranged in parallel with the piston rod and by means of which, in the “brake-by-wire” operating mode, a restoring force acting on the brake pedal can be simulated independently of actuation of the brake booster, wherein, in order to decouple a force-transmitting connection between the brake pedal and the brake booster in the “brake-by-wire” operating mode, a distance is provided between the brake pedal or a component assigned to the brake pedal and a component arranged downstream in the force flux and assigned to the brake booster, in order to decouple the brake pedal from reactive forces of the motor vehicle braking system in the “brake-by-wire” operating mode, and wherein means are provided for automatically reducing the distance outside the “brake-by-wire” operating mode.

### BACKGROUND OF THE INVENTION

Such a brake actuator unit is known from WO 2004/005095 A1, which is incorporated by reference, and is in widespread use in modern motor vehicles with a hybrid drive. The decoupling between the brake pedal and the brake booster in the “brake-by-wire” operating mode is carried out here by means of a gap or a distance between a component which is assigned to the brake pedal and a component which is assigned to the brake booster.

This gap is generally defined in such a way that in the event of a deceleration to as far as, for example, 0.3 g, the brake pedal can be actuated only using the generator without the brake pedal actuating the brake booster. So that no delay occurs at the build-up of the brake pressure when there is a changeover from the “brake-by-wire” operating mode to actuation carried out by means of the muscle force of the vehicle driver, it is proposed in the cited prior art that the above-mentioned distance be reduced automatically when there is changeover from the “brake-by-wire” operating mode to actuation carried out by means of the muscle force of the vehicle driver. The specified means comprise an electromagnetic actuator which is arranged in the brake booster and which interacts with a block-shaped body, which, when necessary, spans the distance between the two components of the piston rod in a positively locking fashion. The arrangement of the means within the brake booster is considered to be complicated since it is necessary to change the design of the brake booster.

### SUMMARY OF THE INVENTION

One aspect of the invention proposes a brake actuator unit which is improved to this effect.

According to one aspect of the invention, means for automatically reducing the distance are arranged on the brake pedal. A complicated and costly change of the brake booster can therefore be avoided.

A hydraulic unit having a first and a second hydraulic space is preferably provided as means for automatically reducing the distance, wherein a connection between the two spaces can be shut off by a valve which is closed in the currentless state, and the first hydraulic space is bounded by a piston which interacts with the piston rod, with the result that the distance a is formed by a stroke of the piston. The hydraulic unit can also be integrated subsequently as a compact component into existing brake actuator units.

According to one advantageous embodiment of the invention, in the “brake-by-wire” operating mode the piston rod bears against the piston. The setting of the adjustment measure between the brake booster and the pedal unit can therefore be made more precise.

In order to guide an end of the piston rod, a funnel-shaped receptacle which is oriented in the direction of the piston rod is preferably provided, which receptacle is attached in a recess, forming the first hydraulic space, of a housing of the hydraulic unit.

For the purpose of simple attachment, the funnel-shaped receptacle preferably has an axial slot and a radial projection, wherein the projection is held in an internal groove in the inner wall of the recess under spring stress.

Another advantageous embodiment of the invention provides that one end of the piston rod is attached to the piston of the first hydraulic space. The piston is therefore continuously entrained by the piston rod, with the result that no jumps in the force occur.

The end can preferably be attached to the piston by means of a snap-action locking mechanism. The mounting can be simplified by this means.

A simple design of the hydraulic unit is achieved by virtue of the fact that the second hydraulic space is bounded by an elastic plastic cover.

According to another advantageous embodiment, the second hydraulic space is bounded by a spring-pressure-loaded piston.

### BRIEF DESCRIPTION OF THE DRAWINGS

The invention is best understood from the following detailed description when read in connection with the accompanying drawings. Included in the drawings is the following figures:

FIG. 1 shows a brake actuator unit according to a first exemplary embodiment in a spatial illustration;

FIG. 2 shows an enlarged detail of the brake actuator unit according to FIG. 1 in a partially sectional view, and

FIG. 3 shows an enlarged detail of a brake actuator unit according to a second exemplary embodiment in a partially sectional view.

### DETAILED DESCRIPTION OF THE PREFERRED EMBODIMENTS

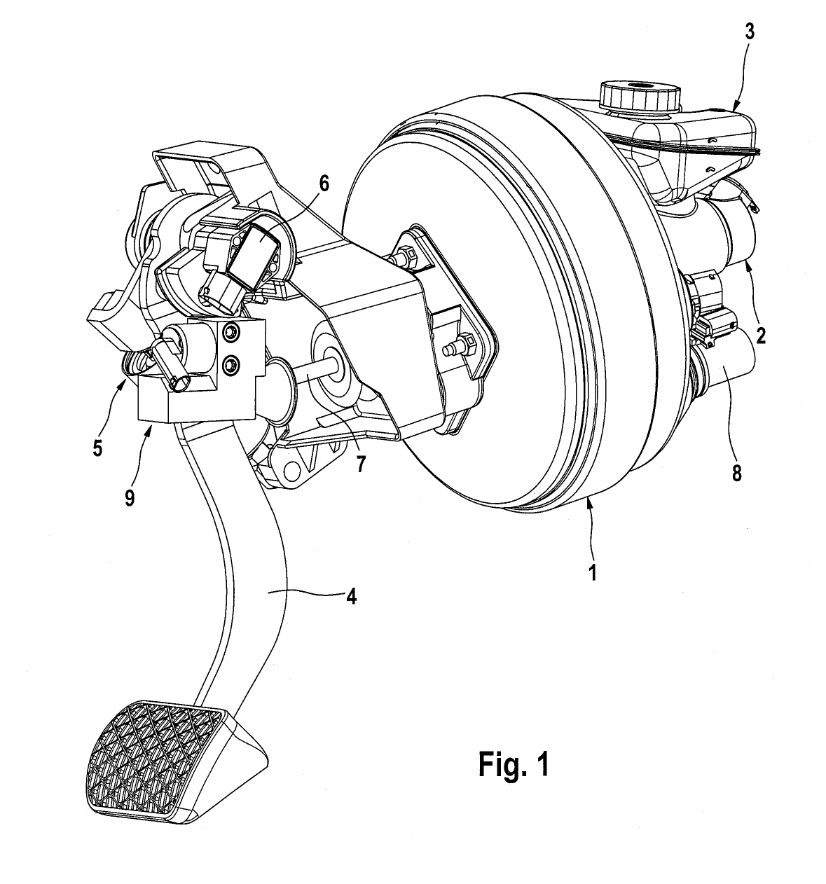

The actuator unit (illustrated spatially in FIG. 1) according to a first exemplary embodiment is composed of a brake booster 1, preferably a partial vacuum brake booster, a master brake cylinder 2, preferably a tandem master cylinder, which is arranged downstream of the brake booster 1 and to whose pressure spaces (not illustrated) wheel brakes of the motor vehicle are connected with intermediate arrangement of a hydraulic open-loop and closed-loop control unit (not illustrated either), and a pressure medium reservoir vessel 3 which is assigned to the master brake cylinder 2. A brake pedal 4 is used by the driver to actuate the brake booster 1, wherein a pedal travel simulator 5, which interacts with the brake pedal 4, in particular in the “brake-by-wire” operating mode, is connected in parallel with a piston rod 7 of the brake booster 1 and conveys the customary brake pedal sensation to the driver, is provided, by means of which pedal travel simulator 5 a restoring force which acts on the brake pedal 4 can be simulated in the “brake-by-wire” operating mode independently of actuation of the brake booster 1. A driver deceleration request or the actuation travel of the brake pedal 4 are sensed by means of at least one sensor device 6 whose signals are fed to an electronic control unit (not shown). Inter alia, an electromagnet which is assigned to the brake booster 1 can be driven by the output signals of the electronic control unit, said electromagnet permitting a pneumatic control valve, which controls an air supply to the brake booster 1, to be actuated independently of the driver's wishes. The piston rod 7 of the brake booster 1 is used by the driver as an input member for actuating the control valve.

For the purpose of decoupling a force-transmitting connection between the brake pedal 4 and the brake booster 1 in the “brake-by-wire” operating mode, a distance a (explained in more detail below) is provided between the brake pedal 4 or a component assigned to the brake pedal 4 and a component arranged downstream in the force flux and assigned to the brake booster 1.

A travel sensor 8 is used to sense the travel of a moveable wall which applies the boosting force of the brake booster 1, or of the travel of an output member of the brake booster 1 which transmits its output force to a first piston (not illustrated) of the master brake cylinder 2.

The aforementioned distance a between the brake pedal 4 or a component assigned to the brake pedal 4 and a component arranged downstream in the force flux and assigned to the brake booster 1 is generally defined in such a way that in the event of a deceleration to as far as, for example, 0.3 g, the brake pedal 4 can be actuated only using the generator without the brake pedal 4 actuating the brake booster 1. So that no delay occurs at the build-up of the braking pressure when there is a changeover from the “brake-by-wire” operating mode to actuation carried out by means of the muscle force of the vehicle driver, the brake actuator unit has means 9 for automatically reducing the distance a outside the “brake-by-wire” operating mode.

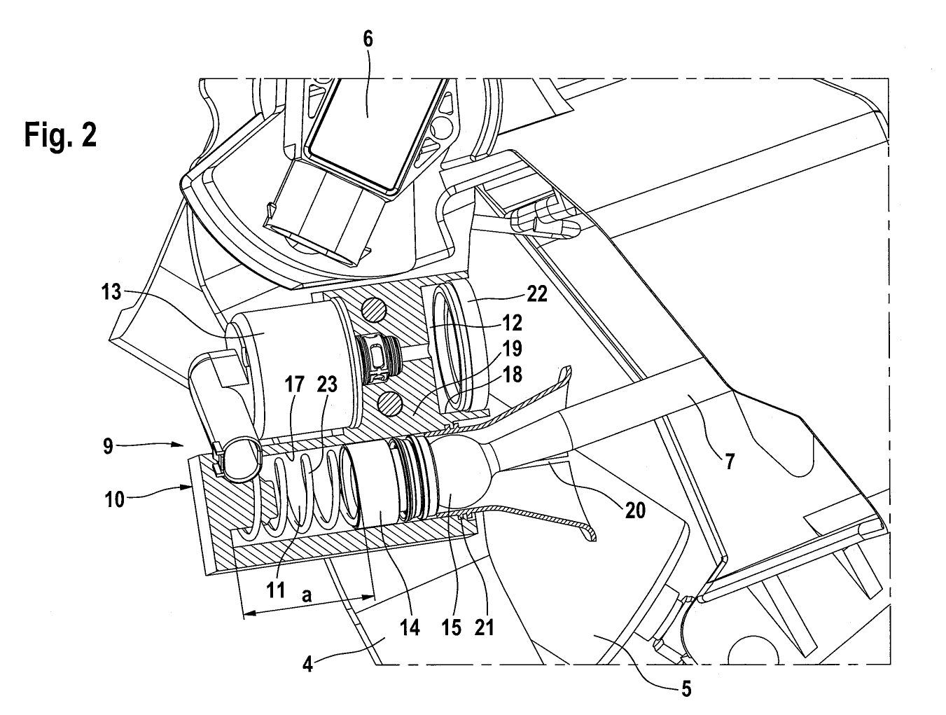

FIG. 2 shows an enlarged, partially sectional detail of the brake actuator unit according to FIG. 1. From this it becomes apparent that the means 9 for automatically reducing the distance a are arranged on the brake pedal 4. Since the means 9 are provided outside the brake booster 1, a corresponding change in the brake booster 1, which is complex and costly, can be dispensed with.

A hydraulic unit 10 having a first and a second hydraulic space 11,12 is provided as means 9 for automatically reducing the distance a. A connection (not illustrated) between the two spaces 11,12 can be shut off by means of a valve 13 which is closed in the currentless state. In the “brake-by-wire” operating mode, the valve 13 is energized and a connection between the spaces 11,12 is open, which are formed by recesses 17,18, open on one side, in a housing 19 of the hydraulic unit 10.

As is apparent from FIG. 2, the first hydraulic space 11 is bounded by a spring-loaded piston 14 which interacts with the piston rod 7, with the result that the distance a is formed by a stroke of the piston 14.

The piston rod 7 or the end 15 thereof—in the form of a ball head here—bears, in particular in the “brake-by-wire” operating mode, on the piston 14, with the result that the setting of the adjustment measure between the brake booster 1 and the brake pedal 4 as part of a pedal unit can therefore be made more precise.

In order to guide the end 15 of the piston rod 7, a funnel-shaped receptacle 16 which is oriented in the direction of the piston rod 7 is provided, which receptacle 16 is attached in the recess 17. The receptacle 16 serves, on the one hand, to guide the end 15 of the piston rod 7 during the assembly of the pedal unit with the brake booster 1. On the other hand, the piston rod 7 is guided by the receptacle 16 after connection to the brake pedal 4.

For the purpose of simple attachment, the funnel-shaped receptacle 16 has an axial slot 20 and a radial projection 21, wherein the projection is held in an internal groove in the recess 17 under spring stress.

In addition, it is apparent from FIG. 2 that the second hydraulic space 12 is bounded by an elastic plastic cover 22.

The method of functioning of the hydraulic unit 10 will be described below:

In the “brake-by-wire” operating mode, the valve 13 is energized and a connection between the spaces 11,12 is open. Therefore, when the brake pedal 4 is actuated, the hydraulic pressure medium which is present in the first hydraulic space 11 flows into the second hydraulic space 12 without obstacles, with the result that no transmission of force occurs between the brake pedal 4 and the piston rod 7 of the brake booster 1. The elastic plastic cover 22 permits limited expansion of the second hydraulic space 12.

When the actuation of the brakes is ended, the hydraulic pressure medium can flow back from the second hydraulic space 12 into the first hydraulic space 11, since the piston 14 is forced back again into its initial position by the spring loading of a restoring spring 23.

If the brake booster 1 is actuated as a result of a brake pressure control process such as ABS, traction control system, ESP etc., independently of a driver's request, or if the brake pedal 4 is suddenly released, the contact between the piston rod 7 and the piston 14 can be interrupted since the end 15 is not attached to the piston 14 but rather only bears thereon.

Outside the “brake-by-wire” operating mode, for example when the electrical system fails, the valve 13 is no longer energized and the connection between the spaces 11, 12 is closed. The hydraulic pressure medium which is present in the first hydraulic space 11 can therefore no longer be forced into the second hydraulic space 12, with the result that forces are transmitted between the brake pedal 4 and the piston rod 7 of the brake booster 1. The distance a is therefore automatically reduced or completely eliminated without delay or idle travel when there is a changeover from the “brake-by-wire” operating mode to actuation carried out by means of the muscle force of the vehicle driver.

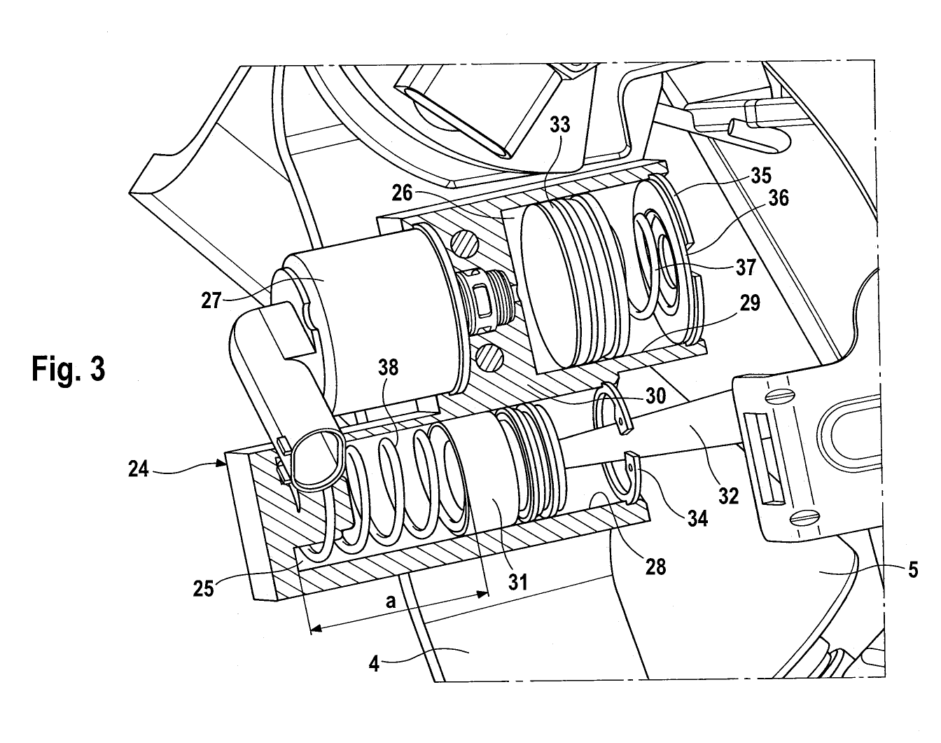

FIG. 3 shows an enlarged, partially sectional detail of a second exemplary embodiment of a brake actuator unit. The latter does not differ in the basic design and in the basic function from the first exemplary embodiment, with the result that details will be given only on the differences.

A hydraulic unit 24 having a first and a second hydraulic space 25,26 is provided as means 9 for automatically reducing the distance a. A connection (not illustrated) between the two spaces 25,26 can be shut off by a valve 27 which is closed in the currentless state. In the “brake-by-wire” operating mode, the valve 27 is energized and a connection between the spaces 25,26, which are formed by recesses 28,29, open on one side, in a housing 30 of the hydraulic unit 24, is open.

As in the case of the first exemplary embodiment according to FIG. 2, the first hydraulic space 25 is also bounded by a spring-loaded piston 31 which interacts with a piston rod 32 of the brake booster 1, with the result that the distance a is formed by a stroke of the piston 31.

An end (not shown) of the piston rod 32 is attached to the piston 31 of the first hydraulic space 25 by means, for example, of a snap-action locking mechanism, with the result that the piston 31 is continuously entrained with the piston rod 32, as a result of which no jumps in force occur. A separate guide element can be eliminated as a result.

Furthermore, the second hydraulic space 26 is, in contrast to the first exemplary embodiment, bounded by a spring-pressure-loaded piston 33. In order to secure the pistons 31,33, a respective securing element 34,35 is provided at the respective end of the recesses 28,29, wherein the securing element 35 of the second hydraulic space 26 holds a stop element 36 for the compression spring 37 which loads the piston 33. However, the plastic cover 22 of the first exemplary embodiment can also be used within the scope of the invention to bound the second space 26, and conversely the spring-loaded piston 33 can also be used in the first exemplary embodiment.

The method of functioning of the hydraulic unit 24 will be described below:

In the “brake-by-wire” operating mode, the valve 27 is energized and a connection between the spaces 25,26 is open. Therefore, when the brake pedal 4 is actuated, the hydraulic pressure medium which is present in the first hydraulic space 25 is displaced into the second hydraulic space 26 counter to the spring force of the compression spring 37, with the result that no transmission of force occurs between the brake pedal 4 and the piston rod 32 of the brake booster 1. When the actuation of the brakes is cancelled, the hydraulic pressure medium can flow back from the second hydraulic space 26 into the first hydraulic space 25, since the piston 31 is pushed back again into its initial position by the spring loading of a restoring spring 38 and the compression spring 37 of the piston 33 forces the pressure medium out of the second hydraulic space 26.

If the brake booster 1 is actuated as a result of a brake pressure control process such as ABS, traction control system, ESP etc., independently of a driver's request, or if the brake pedal 4 is suddenly released, the piston 31 is entrained by the attachment of the piston rod 32 to the piston 31.

Outside the “brake-by-wire” operating mode, for example when the electrical system fails, the valve 27 is no longer energized and the connection between the spaces 25,26 is closed. The hydraulic pressure medium which is present in the first hydraulic space 25 can therefore no longer be forced into the second hydraulic space 26, with the result that forces are transmitted between the brake pedal 4 and the piston rod 32 of the brake booster 1. The distance a is therefore automatically reduced or completely eliminated without delay or idle travel when there is a changeover from the “brake-by-wire” operating mode to actuation carried out by means of the muscle force of the vehicle driver.

The hydraulic units 10,24 can also be subsequently integrated as compact structural units into existing brake actuator units.

### LIST OF REFERENCE SYMBOLS

1 Brake booster
2 Master brake cylinder
3 Pressure medium reservoir vessel
4 Brake pedal
5 Pedal travel simulator
6 Sensor device
7 Piston rod
8 Travel sensor
9 Means
10 Unit
11 Space
12 Space
13 Valve
14 Piston
15 End
16 Receptacle
17 Recess
18 Recess
19 Housing
20 Slot
21 Projection
22 Plastic cover
23 Restoring spring
24 Unit
25 Space
26 Space
27 Valve
28 Recess
29 Recess
30 Housing
31 Piston
32 Piston rod
33 Piston
34 Securing element
35 Securing element
36 Stop element
37 Compression spring
38 Restoring spring
a Distance

1.-9. (canceled)

10. A brake actuator unit for actuating a motor vehicle braking system of the “brake-by-wire” type, comprising:
a brake booster which is configured to be actuated both by a brake pedal and by an electronic control unit as a function of a driver's request, the brake booster having a piston rod,
a master brake cylinder arranged downstream of the brake booster,
means for registering a driver deceleration request,
a pedal travel simulator which interacts with the brake pedal and is arranged in parallel with the piston rod and by which, in a “brake-by-wire” operating mode, a restoring force acting on the brake pedal can be simulated independently of actuation of the brake booster,
wherein, in order to decouple a force-transmitting connection between the brake pedal and the brake booster in the “brake-by-wire” operating mode, a distance (a) is provided between the brake pedal or a component assigned to the brake pedal and a component arranged downstream in the force flux and assigned to the brake booster, in order to decouple the brake pedal from reactive forces of the motor vehicle braking system in the “brake-by-wire” operating mode, and
means are provided for automatically reducing the distance (a) outside the “brake-by-wire” operating mode, wherein the means for automatically reducing the distance (a) are arranged on the brake pedal.

11. The brake actuator unit as claimed in claim 10, wherein the automatic distance reducing means is a hydraulic unit having a first hydraulic space and a second hydraulic space, wherein a connection between the two spaces is configured to be shut off by a valve which is closed in a currentless state, and the first hydraulic space is bounded by a piston which interacts with the piston rod, with the result that the distance (a) is formed by a stroke of the piston.

12. The brake actuator unit as claimed in claim 11, wherein, in the “brake-by-wire” operating mode, the piston rod bears against the piston.

13. The brake actuator unit as claimed in claim 12, wherein in order to guide an end of the piston rod, a funnel-shaped receptacle which is oriented in a direction of the piston rod is provided, which receptacle is attached in a recess, forming the first hydraulic space, of a housing of the hydraulic unit.

14. The brake actuator unit as claimed in claim 13, wherein the funnel-shaped receptacle has an axial slot and a radial projection, wherein the projection is held in an internal groove in the recess under spring stress.

15. The brake actuator unit as claimed in claim 11, wherein one end of the piston rod is attached to the piston of the first hydraulic space.

16. The brake actuator unit as claimed in claim 15, wherein the end of the piston rod is configured to be attached to the piston by a snap-action locking mechanism.

17. The brake actuator unit as claimed in claim 11, wherein the second hydraulic space is bounded by an plastic cover having elastic properties.

18. The brake actuator unit as claimed in claim 11, wherein the second hydraulic space is bounded by a spring-pressure-loaded piston.
